(19) United States
(12) Patent Application Publication
(10) Pub. No.: US 2019/0237981 A1
(43) Pub. Date: Aug. 1, 2019

(54) CHARGING PACKAGE FOR MOBILE COMMUNICATION TERMINAL

(71) Applicants: Sangmook SON, Hanam-si (KR); Kyungsun OH, Seoul (KR)

(72) Inventors: Sangmook SON, Hanam-si (KR); Kyungsun OH, Seoul (KR)

(21) Appl. No.: 16/342,220

(22) PCT Filed: Nov. 16, 2017
(86) PCT No.: PCT/KR2017/013001

§ 371 Date: Apr. 16, 2019

(30) Foreign Application Priority Data
Nov. 28, 2016 (KR) 20-2016-0006896
Feb. 8, 2017 (KR) 20-2017-0000660

(51) Int. Cl. H02J 7/00; H02J 50/40

(52) U.S. Cl. CPC H02J 7/0044; H02J 7/0054; H02J 50/40

(57) ABSTRACT

The present invention relates to a charging package for a wirelessly chargeable terminal, which can supply power to a battery contained in a terminal in a wireless or wired manner. The charging package includes: a housing; a battery pack which is contained inside the housing, and which stores power; a transmission pad which is contained in the housing to wirelessly transmit power stored in the battery pack; and a control circuit which is connected to the transmission pad and the battery pack inside the housing, and in which a first connection port configured to enable external power to be input to the battery pack in a wired manner, a second connection port configured to enable power stored in the battery pack to be output in a wired manner, and a switch configured to control whether to operate the transmission pad are formed to be exposed out of the housing.

### TECHNICAL FIELD

The present invention relates to a charging package for a mobile communication terminal, and more specifically to a charging package for a wirelessly chargeable terminal, which is capable of supplying power to a battery contained in a mobile communication terminal in a wireless or wired manner.

### BACKGROUND ART

As mobile communication service has evolved from the third generation (3G) to the fourth generation (4G), the use of mobile communication terminals has been gradually activated. Accordingly, various real-time communication services as well as map finding using navigation and a location tracking system are provided via mobile communication terminals, and thus the convenience of living is provided.

Such mobile communication terminals are each equipped with a general-purpose operating system (OS) and a web browser, and thus various types of software S/W and programs may be directly installed and used and also Internet content may be freely utilized. Accordingly, the mobile communication terminals are being sold at high price.

Such mobile communication terminals are utilized via applications in real time in buses and subways and during walking and driving due to their excellent portability and various functions, and thus the loss and damage of mobile communication terminals are increasing gradually. Accordingly, many insurances and cases for protecting expensive mobile communication terminals are emerging.

Meanwhile, the basic battery of such a mobile communication terminal is discharged due to its limited capacity when it is used for a predetermined time or longer. Therefore, only when the basic battery separated from the mobile communication terminal is charged, reloaded and then used or is replaced with a separately carried auxiliary battery can the various functions of the mobile terminal be continuously used.

In this case, in order to charge and reuse the discharged battery, a charger must be connected to the battery. Accordingly, when it is difficult to charge the battery due to a long term call, a business trip, a tour, or the like, an auxiliary battery must be carried.

However, such an auxiliary battery is chiefly and simply carried in a bag or a pocket of a garment, and thus there is concern that an auxiliary battery having a small volume is lost.

Furthermore, when the function of such a mobile communication terminal is stopped due to the limited capacity of its basic battery, it is burdensome to replace the basic battery with an auxiliary battery stored in a bag or a pocket of a garment, and thus a problem occurs in that the inconvenience of use is incurred.

### DISCLOSURE

### Technical Problem

An object of the present invention is to provide a charging package having a battery charging function for a wirelessly chargeable terminal, which is capable of supplying power in a wireless or wired manner without requiring the work of replacing a battery when a battery contained in a mobile communication terminal has been discharged.

### Technical Solution

In order to accomplish the above object, according to a preferred embodiment of the present invention, there is provided a charging package for a wirelessly chargeable terminal, the charging package including: a housing; a battery pack which is contained inside the housing, and which stores power; a transmission pad which is contained in the housing to wirelessly transmit power stored in the battery pack; and a control circuit which is connected to the transmission pad and the battery pack inside the housing, and in which a first connection port configured to enable external power to be input to the battery pack in a wired manner, a second connection port configured to enable power stored in the battery pack to be output in a wired manner, and a switch configured to control whether to operate the transmission pad are formed to be exposed out of the housing.

In this case, the charging package may further include: a plurality of magnets which is radially disposed around the transmission pad inside the housing; and a terminal case which includes a metallic material to be separably coupled to the outside of the housing by the magnetic force of the magnets.

Furthermore, the terminal case may include: a reception pad configured to receive power wirelessly transmitted through the transmission pad; and a connection line connected to the charging port of a terminal in a wired manner in order to allow power, provided to the reception pad, to be input to the terminal.

Furthermore, the charging package may further include: a plurality of light emitting lamps which emits illumination light having a different color out of the housing when power is input to or output from the battery pack, and the color of which is variable in order to indicate the charging state of power stored in the battery pack based on the number of lit lamps.

Moreover, the charging package may further include: a cable accommodation member which is separably and tightly fitted into one side of the housing, and inside which a cable configured such that one end thereof is connected to the first connection port and the other end thereof is connected to the second connection port is accommodated.

### Advantageous Effects

As described above, according to the present invention, the housing and the terminal case including metal are separably attached to each other by magnetic force, and the terminal case is provided with the reception pad. Accordingly, the effect of wirelessly supplying power to the battery of a terminal during movement is achieved.

Furthermore, the cable accommodation member which is separably coupled to one side of the housing in a state in which the cable configured to be connected to the first connection port and the second connection port has been accommodated is provided. Accordingly, the effect of eliminating the inconvenience of carrying a cable, the effect of connecting a terminal to a computer anywhere and exchanging data, and the effect of supplying power to the battery pack are achieved.

### DESCRIPTION OF DRAWINGS

FIG. 1 is a schematic perspective view of a charging package for a mobile communication terminal according to one embodiment of the present invention;

FIG. 2 is a schematic exploded perspective view showing the configuration of the charging package for a mobile communication terminal shown in FIG. 1; and

FIGS. 3 and 4 are views showing the operation of the charging package for a mobile communication terminal shown in FIG. 1.

### MODE FOR INVENTION

Preferred embodiments of the present invention will be described in detail below with reference to the accompanying drawings. This is intended to describe the present invention in detail so that those having ordinary knowledge in the art to which the present invention pertains can easily practice the present invention, but does not mean that the technical spirit and scope of the present invention are limited by the above embodiments.

In the drawings, portions unrelated to the detailed description will be omitted in order to clearly describe the present invention. Throughout the specification, like reference symbols are assigned to like portions.

Furthermore, when any portion is described as “including” any component, this means that the portion may further include another component rather than excluding another component, unless specifically described otherwise.

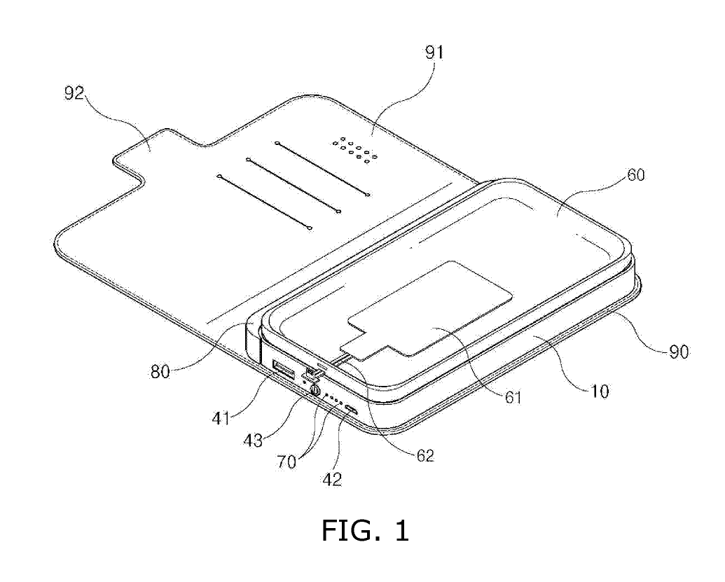

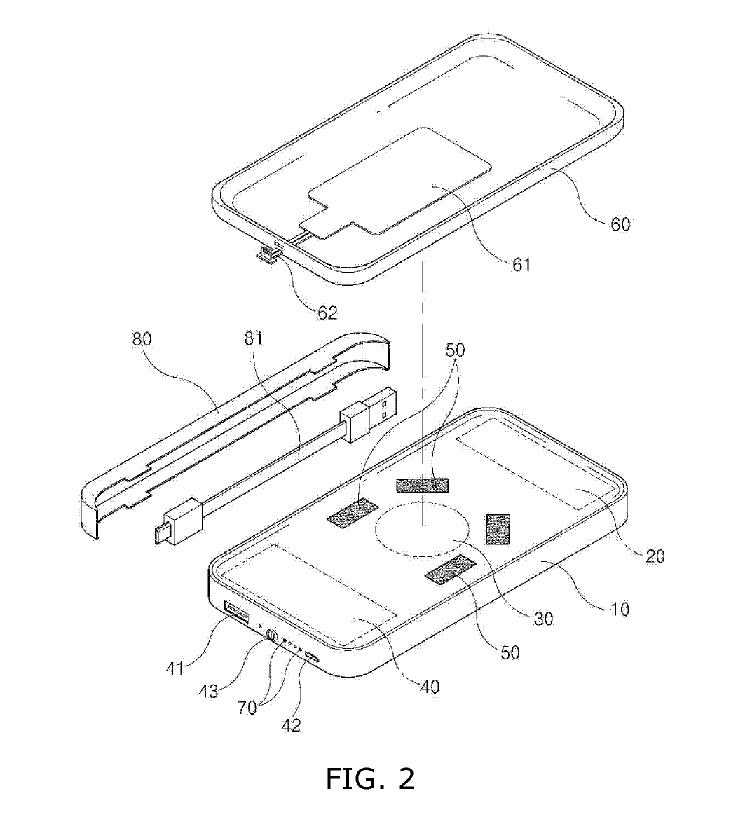

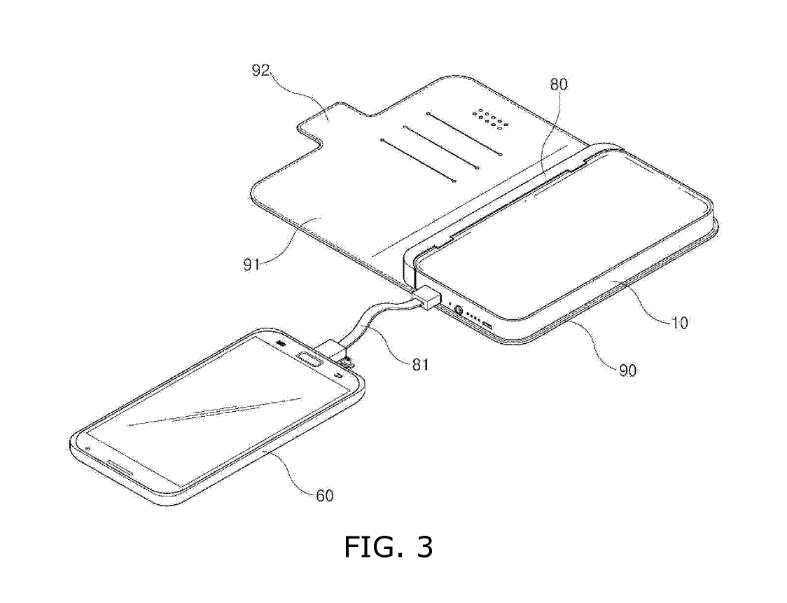

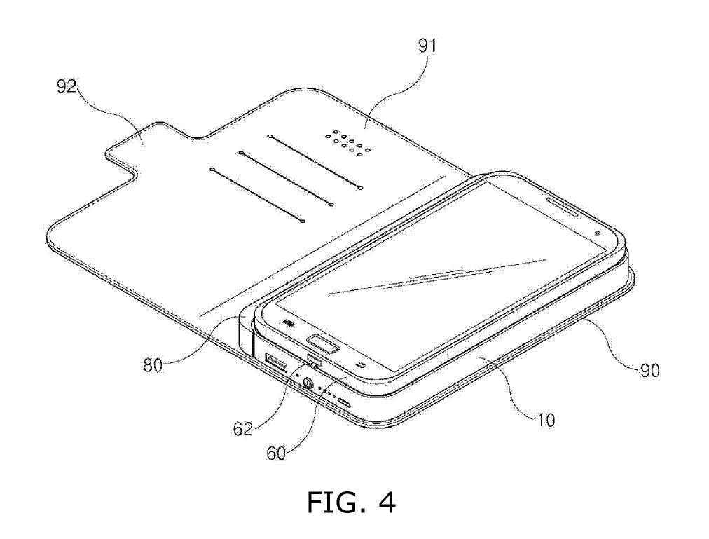

A schematic perspective view of a charging package for a mobile communication terminal according to an embodiment of the present invention is shown in FIG. 1, a schematic exploded perspective view showing the configuration of the charging package for a mobile communication terminal shown in FIG. 1 is shown in FIG. 2, and views showing the operation of the charging package for a mobile communication terminal shown in FIG. 1 are shown in FIGS. 3 and 4.

A charging package for a mobile communication terminal according to a preferred embodiment of the present invention includes: a housing 10; a battery pack 20 which is contained inside the housing 10 and stores power; a transmission pad which is contained in the housing 10 to wirelessly transmit power stored in the battery pack 20; and a control circuit 40 which is connected to the battery pack 20 and the transmission pad 30 inside the housing 10, and in which a first connection port 41 configured to enable external power to be input to the battery pack 20 in a wired manner, a second connection port 42 configured to enable power stored in the battery pack 20 to be output in a wired manner, and a switch 43 configured to control whether to operate the transmission pad 30 are formed to be exposed out of the housing 10.

In this case, the housing 10 operably accommodates the battery pack 20, the transmission pad 30 and the control circuit 40 therein, and is formed in a rectangular box shape.

The battery pack 20 is installed inside the housing 10, and functions to receive power from the outside through the first connection port 41 or to supply power to a terminal through the transmission pad 30 or second connection port 42.

Furthermore, the transmission pad 30 is installed inside, and functions to wirelessly transmit power stored in the battery pack 20 under the control of the control circuit 40.

In other words, the transmission pad 30 allows the wireless charging of a terminal containing a device capable of wirelessly receiving power transmitted from the battery pack 20 when the terminal is detected as being close within a preset range, and switches to an inactive state and also stops wireless charging when the terminal moves out of the preset range.

Furthermore, the control circuit 40 functions to supply external power to the battery pack 20 in a wired manner or to supply power stored in the battery pack 20 to a terminal in a wired manner while controlling whether to operate the transmission pad 30.

More specifically, in the control circuit 40, the first connection port 41 configured to enable external power to be input to the battery pack 20 in a wired manner, the second connection port 42 configured to enable power stored in the battery pack 20 to be output in a wired manner, and the switch 43 configured to control whether to operate the transmission pad 30 are connected to be exposed to the outside.

In this case, the first connection port 41 is set to a port that is the same as the charging port of a terminal, and the second connection port 42 is set to a port that is the same as a USB port that is connected to a USB terminal. Accordingly, detailed descriptions thereof will be omitted for the sake of the brevity of the specification.

Meanwhile, magnets 50 which are radially disposed around the transmission pad 30 and a terminal case 60 which includes a metallic material may be further included inside the charging package 1 for a mobile communication terminal according to the present invention.

The above-described magnets 50 function to allow the terminal case 60 to be separably coupled by means of magnetic force, and the terminal case 60 functions to accommodate a terminal therein.

Accordingly, the terminal case 60 including a metal material may be fastened in an attached form. When a terminal containing a device capable of wirelessly receiving power transmitted from the battery pack 20 is mounted in the terminal case 60, it is considerably easy to make the terminal be detected as being close within the preset range from the transmission pad 30, and the battery of the terminal may be wirelessly charged with power during movement.

In this case, when a terminal not containing a device capable of wirelessly receiving power transmitted from the battery pack 20 is mounted in the terminal case 60, a disadvantage arises in that the battery of the terminal may not be wirelessly charged.

For this purpose, the terminal case 60 may include a reception pad 61 configured to receive power which is wirelessly transmitted through the transmission pad 30, and a connection line 62 connected to a charging port of a terminal in a wired manner in order to allow power provided to the reception pad 61 to be input to the terminal.

In other words, when the connection line 62 is connected to the charging terminal of a terminal, even a terminal not containing a device capable of wirelessly receiving power transmitted from the battery pack 20 may receive power, transmitted from the battery pack 20 by the transmission pad 30, through the reception pad 61.

Furthermore, the charging package 1 for a mobile communication terminal according to the present invention further includes a plurality of light emitting lamps 70 which emits illumination light having a different color to the outside of the housing 10 when power is input to or output from the battery pack 20 and the color of which is variable in order to indicate the charging state of power stored in the battery pack 20 based on the number of lit lamps.

For example, when external power is input to the battery pack 20 through the first connection port 41, the plurality of light emitting lamps 70 emits red light. In contrast, when power stored in the battery pack 20 is output to a terminal through the second connection port 42, the plurality of light emitting lamps 70 emits green light.

Furthermore, when the plurality of light emitting lamps 70 is all lit, this indicates a state which is full of power stored in the battery pack 20. In contrast, when at least one of the plurality of light emitting lamps 70 is lit, this indicates a state in which an amount of power stored in the battery pack 20, which is proportional to the number of unlit lamps, has been consumed.

Therefore, a user may easily determine whether the battery pack 20 has been charged and whether the transmission pad 30 operates from the outside, and also the charging state of the battery pack 20 may be determined. Accordingly, an advantage arises in that the battery pack 20 may be prevented from being left for a long time notwithstanding that the charging of the battery pack 20 has been completed.

Furthermore, the charging package 1 for a mobile communication terminal according to the present invention further includes a cable accommodation member 80 which is separably and tightly fitted into one side of the housing and inside which a cable 81 configured such that one end thereof is connected to the first connection port 41 and the other end thereof is connected to the second connection port 42 is accommodated.

In other words, when it is necessary to supply external power to the battery pack 20 in a state in which the cable 81 has been taken out of the cable accommodation member 80, one end of the cable 81 is connected to the first connection port 41, and the other end of the cable 81 is connected to an external connection port.

Furthermore, when it is necessary to supply power, stored in the battery pack 20, to a terminal through the cable 81 in a state in which the cable 81 has been taken out of the cable accommodation member 80, the other end of the cable 81 is connected to the second connection port 42, and one end of the cable is connected to the charging port of a terminal.

Accordingly, advantages arise in that the cable 81 may be prevented from being lost, the inconvenience of carrying a separate cable may be eliminated, and portability is not impaired because a compact size may be maintained without change even when the cable 81 has been accommodated.

Meanwhile, there may be further included a protective case 90 inside which the housing 10 is fixedly located, and on one side of which a cover 91 configured to selectively open and close the liquid crystals of a terminal based on the rotation thereof is provided.

Leather or one of various fabrics functioning to decorate is used for the outer sides of the protective case 90 and the cover 91, and a fabric made of soft material capable of protecting a terminal is used for the inner skins of the protective case 90 and the cover 91.

In this case, the cover 91 is provided with a fastening member 92. The fastening member 92 functions to fasten the cover 91 to a protective case side. One of various methods, such as a magnetic material, a Velcro fastener, and a snap button, may be applied to the portions of the protective case 90 and the cover 91 which come into contact with each other.

1. A charging package for a wirelessly chargeable terminal, the charging package comprising:
a housing;
a battery pack which is contained inside the housing and, which stores power;
a transmission pad which is contained in the housing to wirelessly transmit power stored in the battery pack; and
a control circuit which is connected to the transmission pad and the battery pack inside the housing, and in which a first connection port configured to enable external power to be input to the battery pack in a wired manner, a second connection port configured to enable power stored in the battery pack to be output in a wired manner, and a switch configured to control whether to operate the transmission pad are formed to be exposed out of the housing.

2. The charging package of claim 1, further comprising:
a plurality of magnets which is radially disposed around the transmission pad inside the housing; and
a terminal case which includes a metallic material to be separably coupled to an outside of the housing by magnetic force of the magnets.

3. The charging package of claim 2, wherein the terminal case comprises:
a reception pad configured to receive power wirelessly transmitted through the transmission pad; and
a connection line connected to a charging port of a terminal in a wired manner in order to allow power, provided to the reception pad, to be input to the terminal.

4. The charging package of claim 1, further comprising:
a plurality of light emitting lamps which emits illumination light having a different color out of the housing when power is input to or output from the battery pack, and a color of which is variable in order to indicate a charging state of power stored in the battery pack based on a number of lit lamps.

5. The charging package of claim 1, further comprising:
a cable accommodation member which is separably and tightly fitted into one side of the housing, and inside which a cable configured such that one end thereof is connected to the first connection port and a remaining end thereof is connected to the second connection port is accommodated.
